(19) United States
(12) Patent Application Publication
(10) Pub. No.: US 2022/0046894 A1
(43) Pub. Date: Feb. 17, 2022

(54) Pet Leash Attachment Fixture and Kit

(71) Applicant: Daniel Robert Christopher, Lebanon (US)

(72) Inventor: Daniel Robert Christopher, Lebanon (US)

(21) Appl. No.: 17/398,249

(22) Filed: Aug. 10, 2021

Related U.S. Application Data
(60) Provisional application No. 63/065,801, filed on Aug. 14, 2020.

(51) Int. Cl. A01K 1/04

(52) U.S. Cl. CPC A01K 1/04

(57) ABSTRACT

The present invention is a pet leash attachment fixture and kit. The kit includes a fixture and a lock or a gate. The fixture includes a bracket for mounting on a surface; an extension; and a hook with a lock space. A retractable leash handle may be placed in the hook while the lock is placed onto and around the lock space, holding the handle in place. The lock or gate closes the gap through which the leash handle is placed in the hook so that the leash handle cannot be idly disengaged from the hook.

### CLAIM OF PRIORITY

This application claims the benefit of priority of co-pending U.S. Provisional Patent Application Ser. No. 63/065,801, filed on Aug. 14, 2020.

### FIELD OF THE INVENTION

The present invention relates generally to pet leash accessories and specifically to a fixture to which a pet leash may easily be held and released.

### BACKGROUND

There are millions of dog owners in the world. These dogs need to be walked. At times, an owner may want to leave his dog in a location temporarily with the dog still on the leash. This may be in a yard where a retractable leash may allow the dog a good amount of free range even as the leash handle itself is stationary. It may be outside of a business that does not allow pets. It may even be within the owner's home.

Several commercial products address this need. There is, for example, a mountable bracket including a retractable tie out reel, such as that sold under the trademark LIXIT. This product requires the owner to unhook a leash from a dog's collar or harness and then hook the device onto the dog's collar or harness. This may be difficult with a rambunctious dog; it requires one of the owner's hands be on the collar or harness throughout the transfer, while the other hand does the unhooking and re-hooking, leaving no hands for anything else; and leaves the owner having to carry the leash even after the dog has been secured.

Two other products are designed specifically for use with retractable leashes such as those sold under the trademark FLEXI, which have a grip that forms an opening in the held end of the leash. These products are disclosed in U.S. Pat. No. 6,820,573 to McMullin (hereinafter “McMullin”) and U.S. Pat. No. 9,295,223 to Dodson (hereinafter “Dodson”). McMullin discloses a pet carousel with first and second extensions extending from a rotational member of telescoping pipes. Each of the first and second extensions includes a top and bottom hole. The grip of a retractable leash is positioned between the first and second extensions and is secured in place when a U-shaped pin is threaded through the top and bottom holes of the first and second extensions. McMullin's device has several drawbacks. First, it includes piping that must be hammered into the ground, so there is always the possibility that the dog will drag the entire device out of place. Second, the device again requires both of the owner's hands to secure the leash. The owner must hold the grip in place between the first and second extensions while fumbling to correctly align and insert the U-shaped member with his other hand. McMullin discloses another embodiment in FIGS. 9-13, where instead of top and bottom holes, the first and second extensions include openings through which a block is positioned and then secured with pins placed into the block on either side of the first and second extensions. This solves none of the problems mentioned above. If anything, it is more complicated and requires more parts for the owner to carry with him, locate at the appropriate time, and juggle to assemble.

Dodson discloses a pet leash holder including a first component that is affixable to a permanent structure; a second component with a flat base that is releasably connectable to the first component and includes opposing side plates that extend outward from the flat base, with each side plate including a bore; and a rod that may be disposed through the bores of the side plates. A retractable leash grip may be placed between the opposing side plates and then held in place when the rod is placed through the bores of the side plates. Dodson's holder improves upon McMullin in that it is affixable to a structure and therefore it is very unlikely that a dog would be able to rip it out of place. Like McMullin, however, Dodson still requires that the owner use both hands to secure the leash handle in place and to thread the small rod through the small bores, which may be difficult to accomplish with a rambunctious dog pulling on the leash. Moreover, the handle of the leash is held rigidly parallel to the side plates, with no possibility of side to side pivoting with the dog's motion. A very strong dog could pull hard enough in a side direction to crack or damage the leash handle and/or the side plates.

Therefore there is a need for a pet leash attachment fixture that may be permanently affixed in place; that does not require both of the owner's hands to use; and that is easy to use, even with an active dog at the end of the leash.

### SUMMARY OF THE INVENTION

In its most basic form, the leash attachment kit of the present invention includes a fixture with a bracket; an extension; and a hook and a lock that fits down onto the hook of the fixture.

The fixture and the lock may be manufactured using a variety of materials, such as plastics, metals, resins, or any sufficiently robust material that can withstand attachment using fasteners and the pulling force of the animal being restrained. The material should be weather resistant. The components may be manufactured, for examples, by machining, casting, molding, 3D printing, or any such method of manufacture commonly used in the art or that may be developed to create such components. It is preferred that the lock component be relatively heavy. This may be by making the entire lock of a heavier material or including a weight within the component. The lock is preferably held in place by gravity, so added weight may aid in the secure placement of the lock.

The fixture includes a bracket, an extension, and a hook. The bracket of the fixture is preferably a flat plate that may be mounted on any flat surface. In some embodiments, however, the bracket may be rounded or otherwise non-flat, depending on the surface on which it will be mounted. It is preferred that the bracket be flat, however, and any non-flat surfaces be accommodated by bracket attachment means, discussed below. The extension includes a bracket side extending from the bracket; a hook side opposite from the bracket side; and an extension height extending between an extension top and bottom. The hook includes a lock side attached to the hook side of the extension; a U-shaped side; and a lock space extending between the lock side and the U-shaped side. The U-shaped side includes a U-shape height extending between a U-shape top and bottom; a first U-extension attached to the lock space; a second U-extension substantially parallel to the first U-extension; and a U-connection between the first and second U-extensions. As used herein, “substantially parallel” means the first and second U-extensions are between a 0 and 45° angle from one another. It is preferred that they are completely parallel or at a 0° angle from one another, however. The U-connection is preferably rounded, but may be a straight connection. The lock space has a lock space width extending between the right and left sides of the lock space; a lock space length extending between the lock side and the first U-extension of the U-shaped side; and a lock space height extending between a lock space top and bottom.

The lock includes a lock height extending between a lock top and bottom; a lock width extending between a lock hook side and a lock bracket side; and a slot extending up from the lock bottom toward the lock top. As used herein, it is understood that this extension “toward” the lock top means that the slot does not extend all the way to the lock top. The slot includes a slot width that is slightly greater than the lock space width. The lock width is slightly less than the lock space length. In this way, the lock will fit snugly onto the hook of the fixture with the slot of the lock fitting onto and into the lock space of the hook. The lock also has a lock length extending in the third special dimension not discussed above. The lock length will extend beyond the first U-extension on one side by virtue of the lock's slot being around the first U-extension. On the other side, it is preferred that the lock length extend at least as far as the second U-extension. It need only be wide enough so that the handle of the retractable leash is too large to get through a distance between the lock and the second U-extension, but the lock will fit more securely over the lock space of the hook if the lock length is wide enough for the second U-extension to act as a stop for the lock.

The portion of the lock on one side of the slot is the lock outer side. The lock outer side is preferably the portion of the lock that will be on the other side of the direction of the hook. The portion of the lock on the other side of the slot is the lock inner side. When in use, the lock inner side will preferably be within the hook of the fixture. In some embodiments either the lock outer side or the lock inner side, preferably the lock outer side, includes a catch and a tab. That is to say that the bottom of the lock outer side, which is also the bottom of the slot, includes a small catch that will extend slightly around the bottom of the lock space of the hook The bottom of the lock outer side that includes a catch also preferably includes a tab so that the lock outer side can be pulled slightly to the side to disengage the catch in order to remove the lock. The tab may extend down or out from the lock outer side, or in any configuration to make it easy to grasp and apply sufficient force to disengage the catch. Some embodiments include a catch only without a tab, however. In embodiments that include a catch, the lock outer side must be flexible enough to endure the slight strain to the side due the presence of the catch every time the lock is placed or removed and to snap back into place once the catch is in place or the lock is removed.

As discussed below, it is preferred that the extension portion of the fixture be angled so that the lock space and hook portions of the fixture are angled downward. It is understood, however, that in embodiments where the extension is not angled, the extension may be very nominal and/or combined with the lock space so that the hook is only so far away from the bracket as the lock width. In addition, in some embodiments, contemplated for larger dogs or animals, the extension may be angled upward.

Preferred embodiments of the kit of the present invention also include bracket attachment means for affixing the bracket of the fixture to a surface. For attachment to a flat surface, these means preferably include holes in the bracket and screws to go through the bracket holes and the flat surface behind. These means are not limited to this embodiment, however. One of at least ordinary skill in the art will recognize that there are many ways to affix a flat bracket to a flat surface and each of these ways are contemplated as being within the scope of the invention. In addition, the bracket attachment means may accommodate attachment to non-flat surfaces, such as a round pipe or other custom surface.

Some embodiments of the present invention include a corner installation piece for attaching the fixture to a corner. The corner installation piece includes a flat surface that will be flush with the bracket of the fixture; first and second corner extensions extending from the flat surface; and a groove between the first and second extensions. The groove is preferably a 90° angle so as to fit around most corners, but may be rounded or otherwise customized to fit an unusual structure. It is understood that the corner installation piece may be integrated with the bracket of the fixture. In other words, the corner installation piece is not necessarily a separate component of the kit, but instead, may be part of the fixture of the kit. Embodiments of the present invention that include a corner installation piece preferably include corner installation attachment means for affixing the corner installation piece to a corner. These means are preferably hole through the bracket of the fixture, aligning with a hole through the center of the corner installation piece, where the groove is at its deepest, and a screw that can go through both holes and into the corner on which the present invention is being installed and hold the components securely thereto. In such embodiments, the corner installation attachment means and the bracket attachment means are combined. Other corner installation attachment means may be holes through each of the first and second corner extensions and screws that can go through those holes into the sides of the corner on which the present invention is being installed. These means may be preferred when the corner installation piece is integrated with the bracket of the fixture. Regardless, one of at least ordinary skill in the art will recognize that there are many ways to affix the corner installation piece to a corner, whether it is integrated with the fixture or not, and each of these ways are contemplated as being within the scope of the invention.

In some embodiments of the present invention, the hook side of the extension of the fixture includes a hook side top and a hook side bottom and the hook side of the extension is angled so that the hook side top is farther away from the bracket than the hook side bottom. This downward angle creates a more natural angle for the line coming out of the retractable leash and connected to the animal's collar or harness. Whether the angle is included may be a matter of preference depending on where the fixture is installed; how high off the ground the fixture is installed; the size of the animal; etc.

In preferred embodiments of the present invention, the lock top of the lock includes a lock handle so as to easily grasp the lock during insertion and removal of the lock. The lock handle may take any form commonly used in the art. It may, for example, be a tab, a string loop, a grip with finger openings, etc.

In preferred embodiments, the lock space includes an indent. In other words, the lock space height is less than the U-shape height and the lock space top and the U-shape top are not flush. The differing heights create the indent. In this way, when the lock is positioned on the lock space, the higher U-shape height creates a stop so that the lock cannot move any further forward toward the U-shaped side. In preferred embodiments, the lock will be wide enough that the second U-extension will already create such a stop, but the indent will augment the stop, thereby creating a more nestled fit and reducing strain on the second U-extension in its capacity as a stop.

In some embodiments, the lock top includes a lip at the lock bracket side. In such embodiments, the lock top is wider at the lip than the lock width along the remainder of the lock's height. This lip may reduce strain on the top of the slot of the lock, as it is repeatedly forced down onto the lock space. Some of that force will be shared with the lip.

The U-connection of the U-shaped side of the hook of the fixture is preferably rounded. This roundedness allows for the handle of retractable leash that may be held in the hook to pivot with the animal, rather than being wedged in place. This will avoid potential damage to the hook and/or the leash handle if a strong dog pulls hard to one side. It is understood, however, that some U-connections are straight or angled so that the hook is more boxy than round.

In some embodiments, the hook side of the extension is wider than the bracket side of the extension. This makes the extension T-shaped, with the wide end of the T being next to the lock space. In this way, that wide end provides a stop so that the lock cannot move farther toward the bracket when it is in place.

In some embodiments, the lock right side of the lock, to the right of the slot, and the lock left side, to the left of the slot each include a lock bore, where the lock bores on each side are aligned. In such embodiments, the lock space of the hook also includes a lock space bore, which will align with the lock bores of the lock when the lock is in place. These embodiments also include a pin that is sized so that it may pass through each of the lock bores and the lock space bore so as to hold the lock in position. The pin may take many forms. It may by curved so that it may thread through the bores and hang down on either side. It may have a head on one side, akin to a nail head, that is larger than any of the bores, so that the head is caught against one side of the lock and hangs down on the other. It may be a hitch pin with a swivel lock or clip. It may be the pin of a U-lock or other padlock, especially a U-lock with an extended “U”, such as those used as bicycle locks. The pin could even be a less rigid material than what is generally implied by “pin,” such as a chain or cord that is stiff enough to be easily threaded through the bores but malleable enough to then bend back to be secured to itself with a lock, knot, or otherwise. One of at least ordinary skill in the art will recognize that any such pin commonly used for such purposes may be successfully deployed as described and each of these pins is considered to be within the scope of the present invention.

Some embodiments of the kit of the present invention provide further security through padlock tabs and a padlock. In cases where theft of the dog, the leash, and/or the lock of the kit is possible, the lock may be locked in place around the lock space of the fixture. This is a variation on the embodiment described above where each of the lock and the lock space have bores through which the pin of a padlock are placed to hold the components together. In this embodiment, the lock bottom and the extension bottom include a lock padlock tab and an extension padlock tab, respectively. These tabs align with one another and are protrusions from the lock bottom of the lock and the hook side bottom of the extension with holes through the protrusions. A padlock is also provided to extend through the holes of the tabs and lock the components together. While a padlock is preferred for security purposes, it is understood that the padlock in this embodiment may be replaced with a pin, such as that discussed above, a hook, a spring snap, a swivel eye bolt snap, or any other suitably sized variation that would hold the tabs together.

The present invention addresses all of the disadvantages noted in the prior art. A pet owner can use the kit with one hand. He doesn't need to unhook the dog from its leash. He can hook the handle of the retractable leash onto the hook and immediately have both hands free, as the hook will hold the leash temporarily. The owner can then use either hand to put the lock in place over and around the lock space of the fixture. The lock is not a small pin as used by McMullin or Dodson that may be easily misplaced. The alignment of the lock of the present invention in place is much easier than aligning holes, as with McMullin or Dodson. The present invention also reduces or eliminates tripping hazards, the risk of pet injury from low-lying restraints, and the possibility of the line being buried in snow or ice. While the present invention is envisioned primarily for use with dogs, it is understood that it may be used with other animals; with simple loop leashes as opposed to retractable leashes with handles; and with boats as opposed to animals at all.

In some embodiments of the present invention, the lock is replaced by a gate that is a part of the fixture. In such embodiments, the gap may be between the second U-extension and the extension, as described above, or between the first and second U-extensions. In either instance, the gate is adjustable between an open position, where the leash handle may be moved into position in the hook, and a closed position, where the gap is closed and the leash handle cannot fall out of the fixture. The gate may move inward or outward on a hinge. The gate may also move on tracks disposed on either the extension or the inside of the first U-extension. When the tracks are on the inside of the first U-extension, it is preferred that the fixture also include a spring disposed between the gate and the extension, that encourages the gate to stay in the closed position. In any of these embodiments, it is preferred that the gate include a gate handle to ease the adjustment between the open and closed positions. It is therefore an aspect of the present invention to provide a leash attachment kit with a fixture comprising a bracket, an extension, and a hook and a lock with a slot that fits down onto a lock space of the hook.

It is a further aspect of the present invention to provide bracket attachment means for affixing the bracket of the fixture to a surface.

It is a further aspect of the present invention to provide a corner installation piece with a flat surface for attachment to the bracket of the fixture; first and second extensions from the flat surface; and a groove therebetween.

It is a further aspect of the present invention to provide corner installation means for affixing the corner installation piece to a corner.

It is a further aspect of the present invention to provide an angled extension as a part of the fixture.

It is a further aspect of the present invention to provide a handle on the lock.

It is a further aspect of the present invention to provide an indent in the lock space of the hook so that U-shaped side of the hook provides a stop for the lock.

It is a further aspect of the present invention to provide a lip at the top of the lock that extends slightly over the extension top.

It is a further aspect of the present invention to provide a rounded hook.

It is a further aspect of the present invention to provide a T-shaped extension so that the extension provides a stop for the lock.

It is a further aspect of the present invention to provide bores through the lock and the lock space and a pin that may pass through each of these bores to hold the lock in place with respect to the fixture.

It is a further aspect of the present invention to provide padlock tabs and a padlock.

It is a further aspect of the present invention to provide a lock with a catch and tab.

It is a further aspect of the present invention to provide a fixture with a gate movable between an open position and a closed position to close the gap.

It is a further aspect of the present invention to provide the gate moving on tracks.

It is a further aspect of the present invention to provide the gate moving on a hinge.

It is a further aspect of the present invention to provide a hook that is not rounded, but angular, where the first and second U-extensions being “substantially parallel” means that they are angled to one another.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a perspective view of the kit of the present invention with the fixture and lock separated.

FIG. 2a is a perspective view of the kit of the present invention with the fixture and lock separated, in use with a retractable leash.

FIG. 2b is a side view of an alternate embodiment of the fixture of the kit of the present invention.

FIG. 2c is a front view of a lock of the present invention with a catch and tab.

FIG. 2d is a perspective view of the kit of the present invention, including a lock with catch and tab, installed and in use.

FIG. 3a is a perspective view of the corner installation piece of the present invention.

FIG. 3b is a top-down diagram of an installation of the corner installation piece.

FIG. 4 is a side view of the kit of the present invention installed and in use.

FIG. 5 is a side view of the kit of the present invention with bores.

FIGS. 6a-6f are various embodiments of a pin.

FIG. 7 is a perspective view of the kit of the present invention with padlock tabs and a padlock.

FIGS. 8a-8c are side views illustrating the operation of the kit of the present invention.

FIGS. 9a-9h are perspective views of embodiments of the fixture of the present invention with a gate.

FIG. 10 is a top down view of a fixture where the hook is not rounded, but angular.

### DETAILED DESCRIPTION

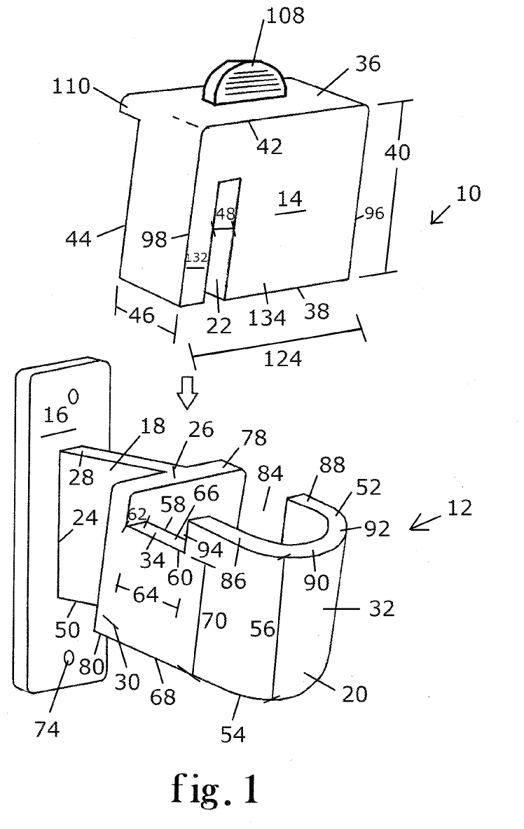

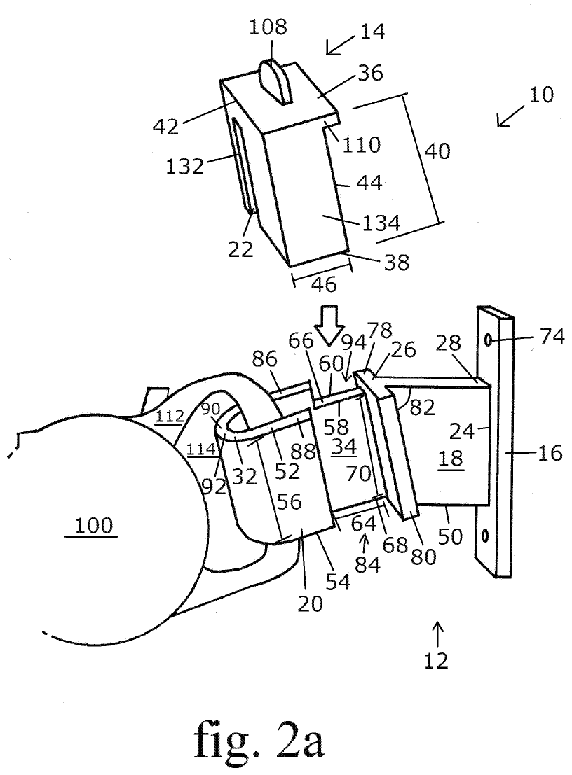

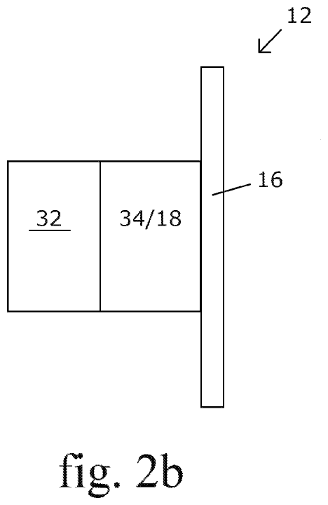

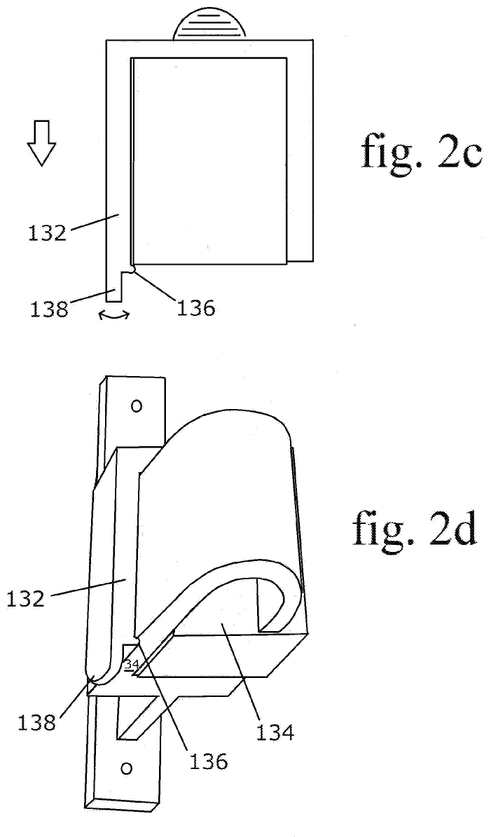

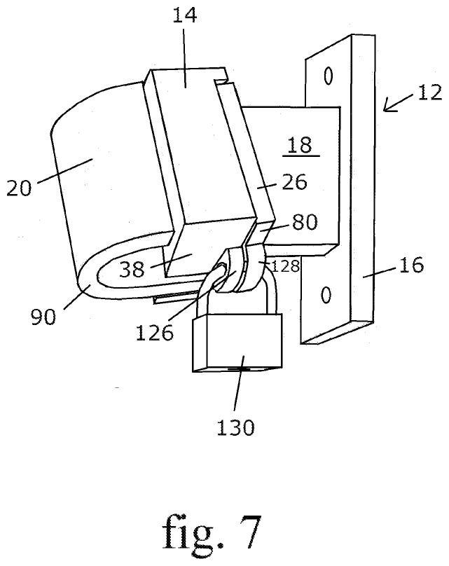

Referring first to FIGS. 1 and 2a, perspective views of the kit of the present invention are provided. Kit 10 includes lock 14 and fixture 12. Fixture 12 includes bracket 16 that is affixed to a permanent surface, as shown in FIG. 4, for example. Fixture 12 also includes extension 18 and hook 20, which includes lock space 34. Lock 14 has slot 22 that fits down onto and around lock space 34. Hook 20 also includes first and second U-extensions 86, 88, connected by U-connection 90. When in position over lock space 34, lock length 124 extends on either side of first U-extension 86 and preferably at least as far as second U-extension 88 on the other side. In this way, second U-extension 88 serves as a stop for lock 14 moving farther forward (shown most clearly in FIG. 7). Lock length 124 may be narrower, however, so long as any aperture remaining between right side 96 of lock 14 and second U-extension 88 is less than the width of leash handle 112 of retractable leash 100. If the leash handle 112 is larger than any aperture, then it will not be able to move out of hook 20 when lock 14 is in place.

Lock 14 is a block that is inserted down onto and around lock space 34 of fixture 12. Lock 14 has a lock top 36 and lock bottom 38, with lock height 40 extending therebetween. Lock 14 has lock hook side 42 that is nearer to U-connection 90 and lock bracket side 44 that is nearer to bracket 16, with lock width 46 extending therebetween. Lock 14 also has lock right and left sides 96, 98, with lock length 124 extending therebetween. Lock 14 includes slot 22 that will fit down onto and around lock space 34 of hook 20. Slot 22 has slot width 48, which should be just greater than lock space width 62, so that lock 14 fits snugly around lock space 34. Lock top 36 includes lock handle 108, so as to easily grab lock 14. Lock outer side 132 is the portion of lock 14 on the outer side of slot 22. Lock inner side 134 is the portion of lock 14 in the inner side of slot 22. Lock handle 108 is shown as a simple tab, but may take many forms. Lock top 36 also includes lip 110 extending toward bracket 16 (when lock 14 is in place). Lip 110 rests on top of hook side 26 of extension 18 and may reduce strain on the top of slot 22.

Fixture 12 includes extension 18 between bracket 16 and hook 20. Extension 18 extends out from bracket 16. Extension 18 has bracket side 24, near bracket 16, and hook side 26, near hook 20. Extension 18 also has extension top 28 and bottom 50. As shown, and as is preferred, hook side 26 is wider than bracket side 24, creating a T-shape. This T-shape acts as a backstop for lock 14, when lock 14 is in position around lock space 34. Hook side 26 has hook side top 78 and hook side bottom 80. Extension 18 preferably includes angle 82 so that hook side top 78 is further away from bracket 16 than hook side bottom 80. Referring briefly to FIG. 2b, it is understood that in some embodiments, extension 18 is minimal so that extension 18 and lock space 34 are essentially the same component.

Referring again to FIGS. 1 and 2a, fixture 12 also includes hook 20. Hook 20 extends between lock side 30 and U-shaped side 32. Hook 20 includes lock space 34, first and second U-extensions 86, 88, and U-connection 90. Lock space 34 includes right and left sides 58, 60 with lock space width 62 extending therebetween. As discussed above, slot 22 of lock 14 will fit snugly around lock space width 62, so it is preferred that slot width 48 be just greater than lock space width 62. Lock space 34 also has lock space length 64 extending between hook side 26 of extension 18 and first U-extension 86. Lock space length 64 should be just greater than lock width 46 so that lock 14 fits snugly onto lock space 34. Lock space 34 also includes lock space top 66 and bottom 68 with lock space height 70 extending therebetween. As shown, and as is preferable, lock 34 includes indent 94, so that lock space height 70 is less than U-shape height 56. Indent 94 creates a snug and defined space for lock 14.

First and second U-extensions 86, 88 and U-connection 90 create the “hook” portion of hook 20. As shown, and as is preferable, U-connection 90 has rounding 92 so that leash handle 112 may pivot around at least 180°. U-connection 90 may also be angled so that the U-shape is boxier, however. First and second U-extensions 86, 88 are substantially parallel to one another. As shown, and as is preferable, they are perfectly parallel to one another, forming a 0° angle with one another, but in some embodiments, they may form up to a 45° angle with one another (if they meet or if their lines were extended to meet). U-shaped side 32 has U-shape top 52 and bottom 54, with U-shape height 56 extending therebetween. Hook 20 also includes gap 84. This is the space through which leash handle 112 will pass before being hooked between first and second U-extensions 86, 88. Gap 84 must therefore be at least as big as a standard leash handle 112 size.

Now referring to FIGS. 2c and 2d, kit 10 that includes lock 14 with catch 136 and tab 138 is disclosed. Catch 136 is a small extension at the bottom of lock outer side 132 and slot 22. As shown in FIG. 2d, catch 136 will extend just over the bottom of lock space 34 when lock 14 is placed over lock space 34. This will further aid in keeping lock 14 in place and/or making lock 14 more difficult to displace. Lock outer side 132 will need to be flexible enough to withstand the slight outward strain caused by the presence of catch 136 while lock 14 is being placed and removed, but should relax back into place once catch 136 has caught lock space 34 or when lock 14 is not in place. Tab 138 may also be included at the bottom of lock outer side 132 to make it easier to pull lock outer side 132 away from lock space 34 when removing lock 14. Catch 136 and tab 138 may also be deployed on lock inner side 134 or may be deployed on lock inner side 134 instead of lock outer side 132, but this is not preferred because lock inner side 134 is generally thicker than lock outer side 132 and may therefore be less flexible and easily manipulatable.

Kit 10 preferably includes bracket attachment means 74 for attaching kit 10 to a surface. Bracket attachment means 74 preferably include holes through bracket 16 and corresponding screws, but may include any attachment means commonly used in the art. Although bracket attachment means 74 are shown for attachment to a flat surface, it is understood that the surface for which bracket attachment means 74 accommodate attachment need not be flat, but may be, for example, round, like a round pipe.

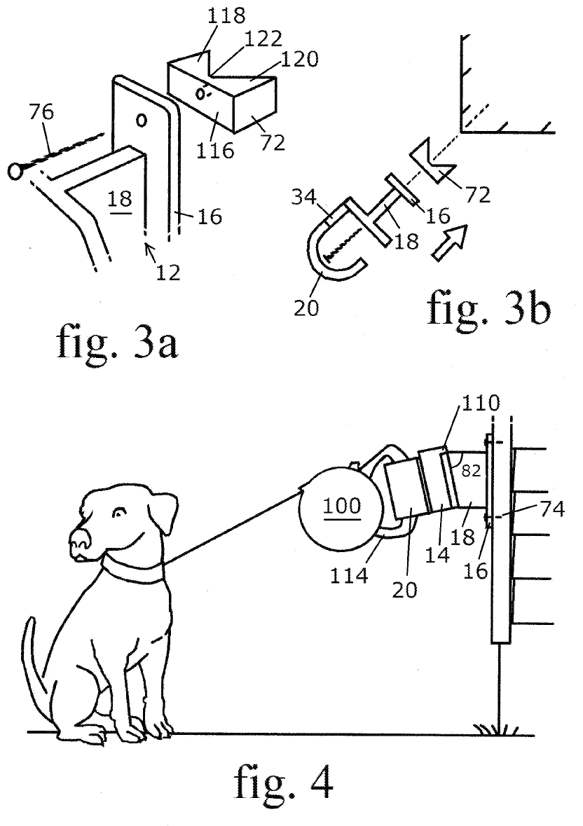

Referring now to FIGS. 3a and 3b, kit 10 may also include corner installation piece 72 and corner installation attachment means 76. Corner installation piece 72 allows kit 10 to be installed on a corner rather than a flat surface. Corner installation piece 72 includes flat surface 116 that will be flush with bracket 16 of fixture 12. Corner installation piece 72 also includes first and second corner extensions 118, 120 with groove 122 therebetween. Groove 122 is preferably a 90° angle, as shown, to fit on a standard corner. Groove 122 may also be rounded or otherwise to fit unusual or custom corners or shapes, however. Corner installation attachment means 76 are means for attaching corner installation piece 72 to a corner. These means 76 may be any commonly used in the art, but are preferably holes and screws, as shown. It is understood that in kits 10 that include a corner installation piece 72 and corner installation attachment means 76, corner installation attachment means 76 and bracket attachment means 74 may be combined. As shown in FIGS. 3a and 3b, this may be in the form of holes in bracket 16 and in corner installation piece 72 that align, and one or more screws sized to go through both. Also, in some embodiments, corner installation piece 72 is integrated with bracket 16 so that corner installation piece 72 is part of fixture 12. In such embodiments, naturally, corner installation attachment means 76 and bracket attachment means 74 are combined.

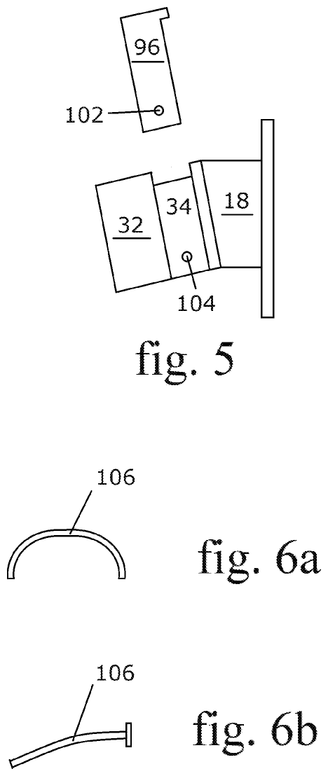

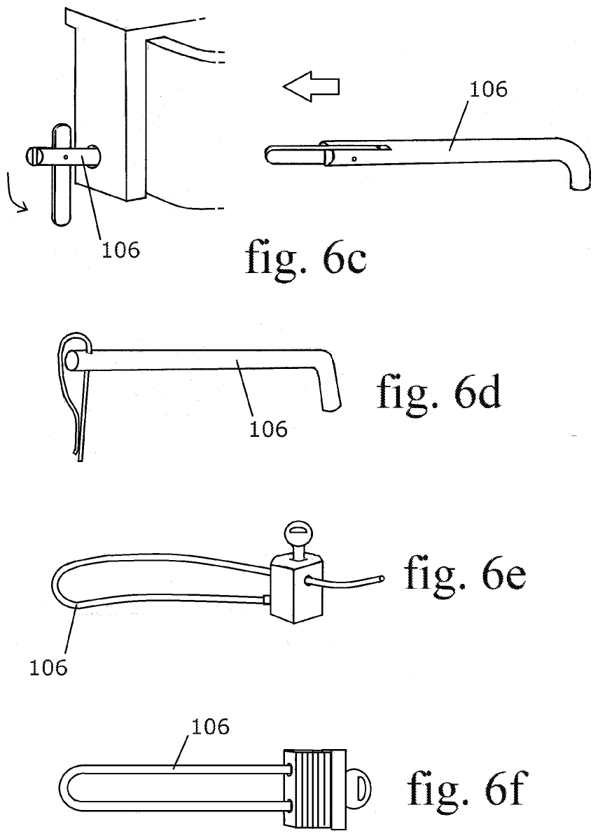

Now referring to FIG. 4, a side view of kit 10 installed and in use is provided. Leash 100 is held securely in place within hook 20. Lock 14 is securely in place over lock space 34 (which cannot be seen in this view because it is covered by lock 14). Lock 14 is stopped from moving forward by second U-extension 88 and stopped from moving backward by the widened T-shape of hook side 26 of extension 18. Lip 110 is just on top of hook side 26 of extension 18. This takes some weight away from slot 22 and may therefore help with wear and tear on the components of kit 10. Angle 82 of extension 18 provides a natural angle of the leash extending down toward the dog. For larger dogs or larger animals generally, angle 82 may be different and may even extend upward so that hook side top 78 is closer to bracket 16 than hook side bottom 80. Bracket 16 is attached to the wall of the house with bracket attachment means 74. Now referring to FIGS. 5 and 6a-6c , a version of kit 10 with bores 102, 104 is provided.

As discussed above, lock 14 is sized to fit snugly onto and around lock space 34. Lock 14 may be weighted to further assure the secure placement of lock 14, thereby using gravity for further assistance. In embodiments such as that shown in FIG. 5, a further feature is provided to ensure that lock 14 will stay in place. Lock 14 includes lock bore 102 extending between lock right and left sides 96, 98 on either side of slot 22. Lock space 34 includes lock space bore 104 that aligns with lock bore 102 when lock 14 is in place. A pin 106 is then placed through lock bore 102 and lock space bore 104 further securing lock 14 in place. Pin 106 may take many forms, a few of which are illustrated in FIGS. 6a-6f. As in FIG. 6a, pin 106 may be a curved pin that will hang down on either side when in place. As in FIG. 6b, pin 106 may have a head that will catch on lock bore 102 on one side and then hang down on the other side. For either of these embodiments of pin 106 and embodiments similar thereto, pin 106 may be attached to fixture 12 by a chain or other means, so that pin 106 is readily accessible and unlikely to be lost or forgotten. As in FIGS. 6c and 6d, pin 106 may be a hitch pin secured, for examples, by a swivel lock (as shown in FIG. 6c) or by a clip (as shown in FIG. 6d). As in FIG. 6e, pin 106 may not be a rigid structure, but may instead be a stiff but malleable twine or chain that may threaded through the bores 102, 104 and then bent back to be secured to itself, such as with a lock, as shown. As in FIG. 6f, pin 106 may be the pin of a padlock or other U-lock, especially those with an extended “U,” such as those used with bicycle locks.

Now referring to FIG. 7, a perspective view of kit 10 including padlock tabs 126, 128 and padlock 130 is provided. Lock padlock tab 126 extends downward from lock bottom 38. Extension padlock tab 128 extends downward from hook side bottom 80 of hook side 26 of extension 18. Lock padlock tab 126 and extension padlock tab 128 align with one another and include holes that align with one another. The pin of padlock 130 is placed through the holes of the padlock tabs 126, 128 so that padlock 130 secures the lock 14 and fixture 12 together. It is understood that padlock 130 may be replaced by any of the pins 106 discussed above with reference to FIGS. 6a-6f or other securing means commonly used in the art, such as a hook, spring snap, or swivel eye bolt snap.

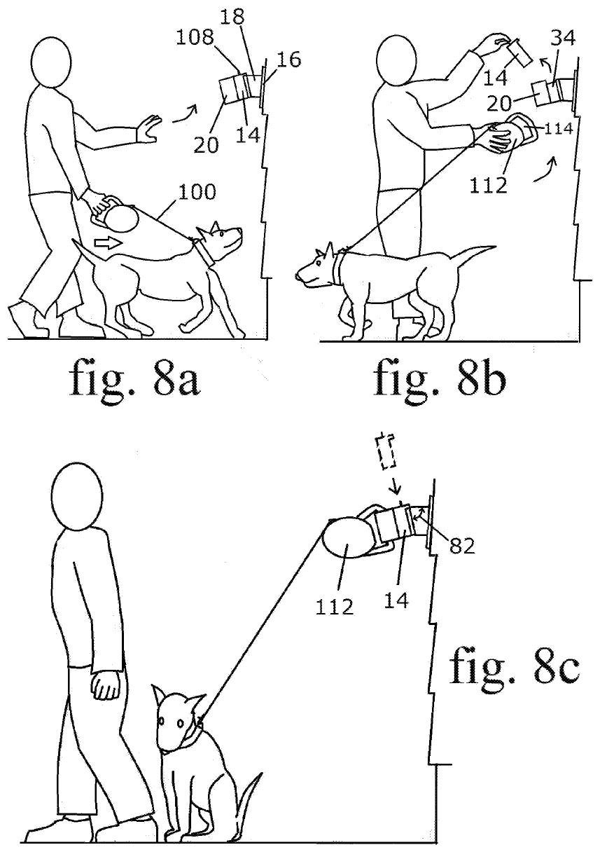

Now referring to FIGS. 8a-8c, use of kit 10 of the present invention is illustrated. Kit 10 is installed on the side of a building. Bracket 16 is visible flush with the building. The dog owner and dog walk up to the installed kit 10, where lock 14 is in place in FIG. 8a. In FIG. 8b, the dog owner lifts lock 14 up by lock handle 108 and easily transfers the opening 114 of the leash handle 112 of the retractable leash 100 onto hook 20. He then replaces lock 14 around lock space 34. In FIG. 8c, leash handle 112 is in place and held there by lock 14. Leash handle 112 may pivot within rounded hook 20 as the dog moves from side to side. Angle 82 of extension 18 is a natural angle for leash 100 so that there is not additional strain on hook 20 or leash handle 112. Leash handle 112 cannot move out of hook 20 while lock 14 is in place, so the owner has peace of mind knowing his dog isn't going anywhere while he steps away for a few minutes.

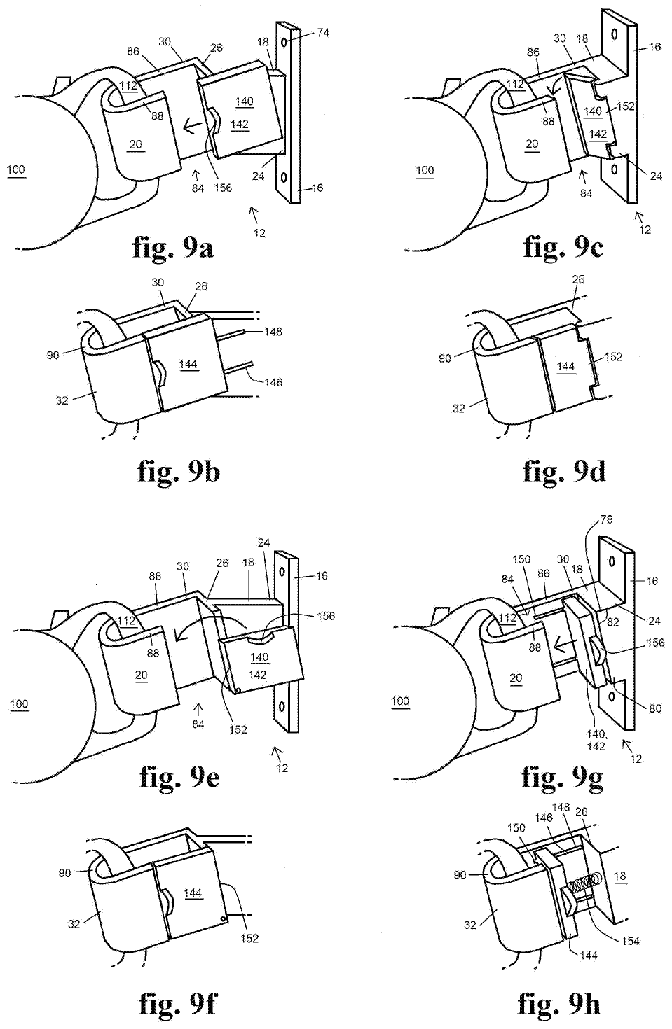

Now referring to FIGS. 9a-9-h, embodiments of fixture 12 that replace lock 14 with gate 140 are disclosed. Gate 140 may be disposed in an open position 142 (as shown in FIGS. 9a, 9c, 9e, and 9g) or in a closed position 144 (as shown in FIGS. 9b, 9d, 9f, and 9h). When gate 140 is in closed position 144, gap 84 is closed. In FIGS. 9a-9f, gap 84 is between second U-extension 88 and extension 18, similar to the embodiments disclosed in FIGS. 1-8c above. As shown in FIGS. 9g and 9h, however, gap 84 may also be disposed between first and second U-extensions 86, 88. In each of these embodiments, it is preferred that gate 140 include gate handle 156 to facilitate moving gate 140 between open position 142 and closed position 144. As described above, it is also preferable that extension 18 include angle 82 to create a downward angle of fixture 12.

Referring specifically to FIGS. 9a and 9b, fixture 12 with gate 140 are shown in the open position 142 and closed position 144, respectively. In this embodiment, extension 18 includes tracks 146 with an open track end 148 (viewable in FIG. 9b only) and a closed track end (obscured by gate 140 in both of FIGS. 9a and 9b but understood to be the opposite end of track 146 from open track end 148). Gate 140 is attached to track 146 such that gate 140 may move along track 146. When gate 140 is disposed at open track end 148, as in FIG. 9a, gate 140 is in open position 142. When gate 140 is disposed at closed track end, as in FIG. 9b, gate 140 is in closed position 144. In this embodiment, gap 84 is between second U-extension 88 and extension 18.

Referring specifically to FIGS. 9c and 9d, fixture 12 with gate 140 are shown in the open position 142 and closed position 144, respectively. In this embodiment, fixture 12 includes hinge 152 attached to both extension 18 and gate 140. Hinge 152 provides the means for gate 140 to move between open position 142, as shown in FIG. 9c, and closed position 144, as shown in FIG. 9d. Gate 140 swings inward on hinge 152 toward first U-extension 86 when gate 140 is in open position 142. In this embodiment, gap 84 is between second U-extension 88 and extension 18.

Referring specifically to FIGS. 9e and 9f, fixture 12 with gate 140 are shown in the open position 142 and closed position 144, respectively. In this embodiment, fixture 12 includes hinge 152 attached to both extension 18 and gate 140. Hinge 152 provides the means for gate 140 to move between open position 142, as shown in FIG. 9e, and closed position 144, as shown in FIG. 9f. Gate 140 swings outward on hinge 152 toward bracket 16 when gate 140 is in open position 142. In this embodiment, gap 84 is between second U-extension 88 and extension 18.

Referring specifically to FIGS. 9g and 9h, fixture 12 with gate 140 are shown in the open position 142 and closed position 144, respectively. In this embodiment, gap 84 is between first and second U-extensions 86, 88. First U-extension 86 includes tracks 146 with an open track end 148 (viewable in FIG. 9h only) and a closed track end 150 (shown most clearly in FIG. 9g). Gate 140 is attached to track 146 such that gate 140 may move along track 146. When gate 140 is disposed at open track end 148, as in FIG. 9g, gate 140 is in open position 142 and is disposed near to lock side 30 of extension 18. When gate 140 is disposed at closed track end 150, as in FIG. 9h, gate 140 is in closed position 144. It is preferred that a spring 154 be disposed between gate 140 and extension 18 so as to encourage gate 140 into remaining in closed position 144.

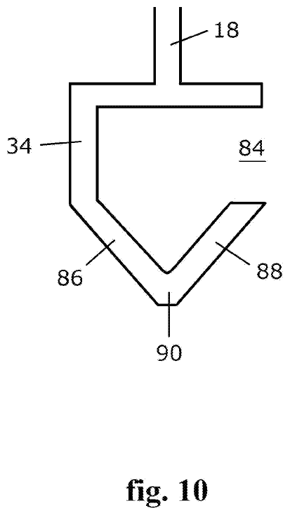

Now referring to FIG. 10, a top down view of fixture 12 where hook 20 is not rounded is provided. As discussed above, rounding 92 is preferred for ease of movement of leash hand 112 within hook 20. In some embodiments, however, first and second U-extensions 86, 88 are not sides of a rounded “U” shape, but more in a “V” shape. As shown in FIG. 10, first and second U-extensions 86, 88 are still “substantially parallel” (as that term is used herein) to one another in that they have up to a 45° angle between them. As in all embodiments, first and second U-extensions 86, 88 meet at U-connection 90. Although lock space 34 is identified, as in FIGS. 1-8c, it is understood that this shape may also be used with any of the embodiments discussed with respect to FIGS. 9a-9h, where that area of fixture 12 is an extended first U-extension 86 and a gate 140 would be included.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

1. A leash attachment kit comprising:
a fixture comprising:
a bracket;
an extension comprising:
a bracket side attached to said bracket;
a hook side;
an extension top; and
an extension bottom;
a hook comprising;
a lock side attached to said hook side of said extension;
a U-shaped side comprising:
a U-shape top;
a U-shape bottom; and
a U-shape height extending between said U-shape top and said U-shape bottom;
a lock space extending between said lock side and U-shaped side comprising:
a right side;
a left side;
a lock space width extending between said right and left sides;
a lock space length extending between said lock side and U-shaped side;
a lock space top;
a lock space bottom; and
a lock space height extending between said lock space top and said lock space bottom;
wherein:
said U-shaped side comprises a first U-extension attached to said lock space, a second U-extension substantially parallel to said first U-extension, and a U-connection between said first and second U-extensions; and
said hook further comprises a gap between said second U-extension and said hook side of said extension such that only said lock space is physically disposed between said hook side of said extension and said U-shaped side of said hook; and
a lock comprising:
a lock top;
a lock bottom;
a lock height extending between said lock top and said lock bottom;
a lock hook side;
a lock bracket side;
a lock width extending between said lock hook side and said lock bracket side; and
a slot extending from said lock bottom toward said lock top, wherein said slot comprises a slot width that is slightly greater than said lock space width of said lock space of said hook;
wherein said lock width is less than said lock space length.

2. The leash attachment kit as claimed in claim 1, further comprising bracket attachment means for affixing said bracket of said fixture to a flat surface.

3. The leash attachment kit as claimed in claim 2, further comprising corner installation attachment means for affixing said corner installation piece to a corner.

4. The leash attachment kit as claimed in claim 3, wherein said corner installation attachment means comprise a corner installation piece comprising:
a flat surface;
first and second corner extensions extending from said flat surface; and
a groove disposed between said first and second extensions.

5. The leash attachment kit as claimed in claim 1, wherein said hook side of said extension of said fixture comprises a hook side top, a hook side bottom, and an angle such that said hook side top is farther away from said bracket than said hook side bottom.

6. The leash attachment kit as claimed in claim 1, wherein said lock space of said hook further comprises an indent such that:
said lock space height is less than said U-shape height; and
said lock space top and said U-shape top are not flush.

7. The leash attachment kit as claimed in claim 1, wherein said lock top comprises a lip at said lock bracket side such that said lock top is wider than said lock width at said lip.

8. The leash attachment kit as claimed in claim 1, wherein said U-connection end is rounded.

9. The leash attachment kit as claimed in claim 1, wherein said hook side of said extension is wider than said bracket side of said extension.

10. The leash attachment kit as claimed in claim 1, wherein:
said lock further comprises a lock right side to the right of said slot and a lock left side to said left of said slot;
each of said lock right and left sides comprises a lock bore, wherein said lock bore of said lock right side is aligned with said lock bore of said lock left side;
said lock space of said hook of said fixture further comprises a lock space bore;
said leash attachment kit further comprises a pin sized to fit through said lock bores and said lock space bore; and
said lock space bore is disposed through said lock space such that said pin is capable of being disposed through each of said lock bores and said lock space bore simultaneously.

11. A leash attachment fixture comprising:
a bracket;
an extension comprising:
a bracket side attached to said bracket; and
a hook side;
a hook comprising;
a lock side attached to said hook side of said extension;
a U-shaped side comprising a first U-extension extending from said lock side, a second U-extension substantially parallel to said first U-extension, and a U-connection between said first and second U-extensions; and
a gap disposed between one of a group consisting of (said second U-extension and said hook side of said extension) and (said first and second U-extensions); and
a gate adjustable between an open position in which said gap of said hook is open and a closed position in which said gap of said hook is closed.

12. The leash attachment fixture as claimed in claim 11, wherein:
said gap is disposed between said second U-extension and said hook side of said extension;
said extension further comprises a track with an open track end and a closed track end;
said gate is attached to said tracks such that said gate moves along said track;
said gate is in said open position when said gate is positioned at said open track end of said track; and
said gate is in said closed position when said gate is positioned at said closed track end of said track.

13. The leash attachment fixture as claimed in claim 11, further comprising a hinge attached to said extension and said gate, wherein:
said hinge facilitates adjustability of said gate between said open position and said closed position; and
said gate moves inward toward said first U-extension of said hook when in said open position.

14. The leash attachment fixture as claimed in claim 11, further comprising a hinge attached to said extension and said gate, wherein:
said hinge facilitates adjustability of said gate between said open position and said closed position; and
said gate moves outward toward said bracket when in said open position.

15. The leash attachment fixture as claimed in claim 11, wherein:
said gap is disposed between said first and second U-extensions;
said first U-extension comprises a track with an open track end and a closed track end;
said gate is attached to said tracks such that said gate moves along said track;
said gate is in said open position when said gate is positioned at said open track end of said track; and
said gate is in said closed position when said gate is positioned at said closed track end of said track.

16. The leash attachment fixture as claimed in claim 15, further comprising a spring disposed between said gate and said extension.

17. The leash attachment fixture as claimed in claim 11, wherein said gate comprises a gate handle.

18. The leash attachment fixture as claimed in claim 11, further comprising bracket attachment means for affixing said bracket to a flat surface.

19. The leash attachment fixture as claimed in claim 18, further comprising corner installation attachment means for affixing said fixture to a corner.

20. The leash attachment kit as claimed in claim 19, wherein said hook side of said extension of said fixture comprises a hook side top, a hook side bottom, and an angle such that said hook side top is farther away from said bracket than said hook side bottom.
